(19) United States
(12) Patent Application Publication
(10) Pub. No.: US 2022/0383198 A1
(43) Pub. Date: Dec. 1, 2022

(54) METHOD FOR ASYNCHRONOUS FEDERATED LEARNING, METHOD FOR PREDICTING BUSINESS SERVICE, APPARATUS, AND SYSTEM

(71) Applicant: BEIJING BAIDU NETCOM SCIENCE TECHNOLOGY CO., LTD., Beijing (CN)

(72) Inventors: Ji LIU, Beijing (CN); Chendi ZHOU, Beijing (CN); Shilei JI, Beijing (CN); Dejing DOU, Beijing (CN)

(73) Assignee: BEIJING BAIDU NETCOM SCIENCE TECHNOLOGY CO., LTD., Beijing (CN)

(21) Appl. No.: 17/879,888

(22) Filed: Aug. 3, 2022

(30) Foreign Application Priority Data
Feb. 17, 2022 (CN) 2022101484783

(51) Int. Cl. G06N 20/00; G06Q 10/04; G06Q 10/06

(52) U.S. Cl. CPC G06N 20/00; G06Q 10/04; G06Q 10/0639

(57) ABSTRACT

The present disclosure provides a method for asynchronous federated learning, including: in response to a request for participating in asynchronous federated learning sent by a target electronic device, determining, according to performance information of a server, a first number of electronic devices that the server supports to participate in the asynchronous federated learning, and acquiring a second number of other electronic devices that have participated in the asynchronous federated learning; if the first number is greater than the second number, sending a global model to be optimized to the target electronic device, and receiving target feedback information which is obtained by the target electronic device from training on the global model to be optimized; and optimizing, according to the target feedback information, the global model to be optimized to obtain an optimized global model.

### CROSS-REFERENCE TO RELATED APPLICATIONS

This application claims priority to Chinese Patent Application No. 202210148478.3, filed on Feb. 17, 2022, which is hereby incorporated by reference in its entirety.

### TECHNICAL FIELD

The present disclosure relates to big data and machine learning in artificial intelligence technology, particularly to federated learning in machine learning, and especially to a method for asynchronous federated learning, a method for predicting a business service, an apparatus, and a system.

### BACKGROUND

Federated machine learning is also known as federated learning, joint learning or alliance learning, while asynchronous federated learning refers to federated learning with an asynchronous update mechanism.

In the prior art, a method for asynchronous federated learning includes: a server sending, to respective electronic devices, a global model to be optimized; the respective electronic devices performing training on the global model to be optimized, and obtaining model parameters; the server optimizing, according to the respective model parameters, the global model to be optimized to obtain an optimized global model.

However, with the above-described method, the convergence speed of asynchronous federated learning decreases as the number of electronic devices participating in asynchronous federated learning increases, resulting in a technical problem of low efficiency.

### SUMMARY

The present disclosure provides a method for asynchronous federated learning, a method for predicting a business service, an apparatus and a system.

According to a first aspect of the present disclosure, a method for asynchronous federated learning is provided. The method is applied to a server, and the method includes:

in response to a request for participating in the asynchronous federated learning sent by a target electronic device, determining, according to performance information of the server, a first number of electronic devices that the server supports to participate in the asynchronous federated learning, and acquiring a second number of other electronic devices that have participated in the asynchronous federated learning;

if the first number is greater than the second number, sending a global model to be optimized to the target electronic device, and receiving target feedback information which is obtained by the target electronic device from training on the global model to be optimized; and

optimizing, according to the target feedback information, the global model to be optimized to obtain an optimized global model.

According to a second aspect of the present disclosure, a method for asynchronous federated learning is provided. The method is applied to an electronic device, and the method includes:

initiating a request for participating in the asynchronous federated learning to a server, and receiving a global model to be optimized that is fed back by the server based on the request for participating in the asynchronous federated learning, where the global model to be optimized is received when a first number is greater than a second number, the first number is a number of electronic devices that the server supports to participate in the asynchronous federated learning determined according to performance information of the server, and the second number is an acquired number of other electronic devices that have participated in the asynchronous federated learning; and

performing training on the global model to be optimized to obtain target feedback information, and transmitting the target feedback information to the server, where the target feedback information is used to optimize the global model to be optimized to obtain an optimized global model.

According to a third aspect of the present disclosure, a method for predicting a business service is provided, including:

acquiring a prediction request, where the prediction request is used to request prediction of a target business service; and

predicting the target business service based on an optimized global model that is pre-trained, to obtain a prediction result;

where the optimized global model is obtained based on the method of the first aspect.

According to a fourth aspect of the present disclosure, an electronic device is provided, including:

at least one processor; and

a memory communicatively connected to the at least one processor;

where the memory has, stored therein, an instruction executable by the at least one processor, and the instruction is executed by the at least one processor to enable the at least one processor to execute the method of the first aspect, the second aspect or the third aspect.

The method for the asynchronous federated learning, the method for predicting the business service, the apparatus and the system provided in the embodiments of the present disclosure include the technical features of: determining, in conjunction with performance information of a server, a first number of electronic devices that the server can support to participate in the asynchronous federated learning, and acquiring a second number of other electronic devices that have participated in the asynchronous federated learning; sending a global model to be optimized to a target electronic device when the second number is less than the first number, that is, when the server is still capable of supporting the target electronic device to participate in the asynchronous federated learning; and completing the asynchronous federated learning based on target feedback information that is fed back by the target electronic device.

It should be understood that the content described in this section is not intended to identify key or important features in the embodiments of present disclosure, nor is it intended to limit the scope of the present disclosure. Other features of the present disclosure will become readily comprehensible through the following description.

### BRIEF DESCRIPTION OF DRAWINGS

The accompanying drawings are used to better understand the present scheme, but do not constitute a limitation to the present disclosure.

FIG. 1 is a schematic diagram according to a first embodiment of the present disclosure.

FIG. 2 is a schematic diagram of a scenario in which asynchronous federated learning according to an embodiment of the present disclosure can be implemented.

FIG. 3 is a schematic diagram according to a second embodiment of the present disclosure.

FIG. 4 is a schematic diagram according to a third embodiment of the present disclosure.

FIG. 5 is a schematic diagram according to a fourth embodiment of the present disclosure.

FIG. 6 is a schematic diagram according to a fifth embodiment of the present disclosure.

FIG. 7 is a schematic diagram according to a sixth embodiment of the present disclosure.

FIG. 8 is a schematic diagram according to a seventh embodiment of the present disclosure.

FIG. 9 is a schematic diagram according to an eighth embodiment of the present disclosure.

FIG. 10 is a schematic diagram according to a ninth embodiment of the present disclosure.

FIG. 11 is a schematic diagram of a tenth embodiment according to the present disclosure.

FIG. 12 is a block diagram of an electronic device for implementing a method for asynchronous federated learning and a method for predicting a business service according to an embodiment of the present disclosure.

### DESCRIPTION OF EMBODIMENTS

Exemplary embodiments of the present disclosure will be described hereunder with reference to the accompanying drawings, which include therein various details of the embodiments of the present disclosure to facilitate understanding and should be considered as to be merely exemplary. Therefore, those of ordinary skill in the art should realize that various changes and modifications can be made to the embodiments described herein without departing from the scope and spirit of the present disclosure. Likewise, for clarity and conciseness, descriptions of well-known functions and structures are omitted in the following description.

With the increase of various edge devices, such as smart mobile terminals (e.g., smartphones, etc.), Internet of Things devices, mobile sensor devices and the like, more and more data can be used for deep learning model training in different artificial intelligence applications.

In some embodiments, data for model training may be collected by a server, and centralized training is performed in the server based on the collected data.

For example, respective edge devices transmit data respectively acquired by them to the server, accordingly, the server receives the data transmitted by the respective edge devices, and performs centralized training based on all the received data.

However, the use of this method to implement the deep learning model training will bring many problems such as huge communication overheads, limited computing resources, and privacy and security risks.

In order to avoid the above problems, a method for federated learning may be used to implement the deep learning model training. In a deep learning model, local model training can be performed by the edge devices, and global model aggregation can be performed in the server, so as to complete the deep learning model training.

For different datasets, the federated learning can be divided into horizontal federated learning, vertical federated learning and federated transfer learning (FTL).

The horizontal federated learning refers to a deep learning model training method, in which datasets are segmented horizontally (that is, by user dimension) when two datasets overlap more in terms of user features but less in terms of users, and a portion of data with same user features but with not exactly same users is extracted for training.

The vertical federated learning refers to a deep learning model training method, in which datasets are segmented vertically (that is, by feature dimension) when two datasets overlap more in terms of users but less in terms of user features, and a portion of data with same users but with not exactly same user features is extracted for training.

The federated transfer learning refers to a deep learning model training method, in which no segmentation is performed on data when two datasets overlap less in terms of users and user features, and instead the transfer learning is used to overcome insufficient data or labels.

In light of synchronous or not, the federated learning can be divided into synchronous federated learning and asynchronous federated learning.

The asynchronous federated learning refers to: a server sending, to respective edge devices, a global model to be optimized; the respective edge devices asynchronously performing training on the global model to be optimized, and obtaining respective corresponding model parameters; the server optimizing, according to the respective model parameters, the global model to be optimized to obtain an optimized global model.

However, the convergence speed of the asynchronous federated learning decreases as the number of edge devices participating in the asynchronous federated learning increases, resulting in a technical problem of low efficiency.

It should be understood that the asynchronous federated learning may be the horizontal federated learning, the vertical federated learning, or the federated transfer learning. That is to say, in light of the classification of federated learning categories under different classification strategies, federated learning under different classification strategies is not in an exclusive relationship.

In order to avoid at least one of the above-mentioned technical problems, the inventors of the present disclosure come up with the inventive concept of the present disclosure through creative efforts: to limit the number of edge devices participating in the asynchronous federated learning so as to optimize the global model based on a certain number of edge devices.

Based on the above-described inventive concept, the present disclosure provides a method for asynchronous federated learning, a method for predicting a business service and an apparatus, which are applied to big data and machine learning in artificial intelligence technology and particularly to federated learning in machine learning, so as to improve the convergence speed of asynchronous federated learning.

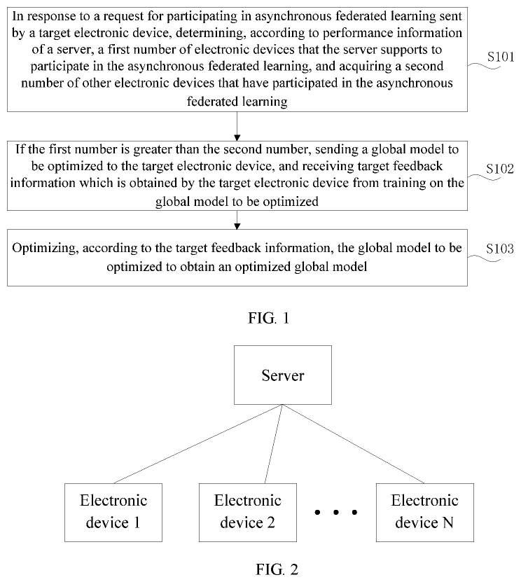

FIG. 1 is a schematic diagram according to a first embodiment of the present disclosure. As shown in FIG. 1, an embodiment of the present disclosure provides a method for asynchronous federated learning. The method can be applied to a server, and the method includes:

S101, in response to a request for participating in the asynchronous federated learning sent by a target electronic device, determining, according to performance information of the server, a first number of electronic devices that the server supports to participate in the asynchronous federated learning, and acquiring a second number of other electronic devices that have participated in the asynchronous federated learning;

Exemplarily, the execution subject of the present embodiment may be an apparatus for asynchronous federated learning, and the apparatus may be a server.

It should be understood that the word “target” in the target electronic device is used to distinguish the electronic device from other electronic devices, and cannot be understood as a limitation on the target electronic device.

That is to say, the target electronic device can be interpreted as an electronic device that currently communicates with the server, which is one of many electronic devices.

FIG. 2 is a schematic diagram of a scenario in which a method for asynchronous federated learning according to an embodiment of the present disclosure is applied. In conjunction with FIG. 2 and the above analysis, it can be seen that a server and a plurality of electronic devices (the electronic devices may also be termed as edge devices) are included in an environment of the asynchronous federated learning.

As shown in FIG. 2, N electronic devices are included in the environment of the asynchronous federated learning, which are an electronic device 1, an electronic device 2, . . . , and an electronic device N.

If the target electronic device is the electronic device 1 as shown in FIG. 2, the present embodiment may be comprehended as follows.

The electronic device 1 can send a request for participating in the asynchronous federated learning to the server.

Correspondingly, the server can receive the request for participating in the asynchronous federated learning sent by the electronic device 1. When the server receives the request for participating in the asynchronous federated learning, the server can determine a first number according to performance information of the server, and determine a second number.

The performance information can be interpreted as information related to a performance parameter of the server, such as load capacity, processor utilization or the like, and enumerations will be omitted here.

The second number can be comprehended as follows: before receiving the request for participating in the asynchronous federated learning sent by the electronic device 1, the server might have received requests for participating in the asynchronous federated learning sent by other electronic devices, and the second number is the number of electronic devices whose requests for participating in the asynchronous federated learning from the other electronic devices have been received.

For example, if, before receiving the request for participating in the asynchronous federated learning sent by the electronic device 1, the server has received requests for participating in the asynchronous federated learning sent by the electronic device 2 and the electronic device N respectively, then the second number is 2.

S102, if the first number is greater than the second number, sending a global model to be optimized to the target electronic device, and receiving target feedback information which is obtained by the target electronic device from training on the global model to be optimized.

Exemplarily, in conjunction with the above analysis, after determining the first number and the second number, the server may compare the first number with the second number, for example, determine whether the first number is greater than the second number, and if yes (that is, the first number is greater than the second number), the server sends a global model to be optimized to the electronic device 1.

Correspondingly, after receiving the global model to be optimized, the electronic device 1 can perform training on the model to be optimized so as to obtain target feedback information, and transmit the target feedback information to the server.

In some embodiments, the first number may also be less than or equal to the second number, in which case, the server does not send the global model to be optimized to the electronic device 1 so as to avoid a potential risk that the server is overloaded due to too many participants, thereby achieving technical effects of improving reliability and stability of the asynchronous federated learning.

Similarly, in the present embodiment, the word “target” in the target feedback information is used for a distinction from feedback information of other electronic devices, and cannot be understood as a limitation on the target feedback information.

It is worth mentioning that, in the present embodiment, the server sends the global model to be optimized to the target electronic device when the first number is greater than the second number, instead of directly sending the global model to be optimized to the target electronic device upon reception of the request for participating in the asynchronous federated learning, this takes the performance information of the server into full consideration so as to avoid a potential risk that the server is overloaded since too many electronic devices participate in the asynchronous federated learning, thereby effectively ensuring the convergence speed of the asynchronous federated learning, and achieving technical effects of improving effectiveness and reliability of the asynchronous federated learning.

S103, optimizing, according to the target feedback information, the global model to be optimized to obtain an optimized global model.

Exemplarily, upon reception of the target feedback information, the server may optimize, based on the target feedback information, the global model to be optimized to obtain an optimized global model. The optimization mode is not limited in the present embodiment.

Based on the above analysis, it can be seen that the embodiment of the present disclosure provides a method for asynchronous federated learning. The method can be applied to a server, and the method includes: in response to a request for participating in the asynchronous federated learning sent by a target electronic device, determining, according to performance information of the server, a first number of electronic devices that the server supports to participate in the asynchronous federated learning, and acquiring a second number of other electronic devices that have participated in the asynchronous federated learning; if the first number is greater than the second number, sending a global model to be optimized to the target electronic device, and receiving target feedback information which is obtained by the target electronic device from training on the global model to be optimized; and optimizing, according to the target feedback information, the global model to be optimized to obtain an optimized global model. In the present embodiment, through the technical features of: determining, in conjunction with the performance information of the server, the first number of electronic devices that the server can support to participate in the asynchronous federated learning, and acquiring the second number of the other electronic devices that have participated in the asynchronous federated learning; and sending the global model to be optimized to the target electronic device when the second number is less than the first number, that is, when the server is still capable of supporting the target electronic device to participate in the asynchronous federated learning; and completing the asynchronous federated learning based on the target feedback information that is fed back by the target electronic device, a disadvantage in related technologies is avoided in terms of the server being overloaded due to an excessive number of electronic devices participating in the asynchronous federated learning, and the convergence speed of obtaining the optimized global model is effectively ensured, thereby achieving technical effects of improving effectiveness and reliability of the asynchronous federated learning.

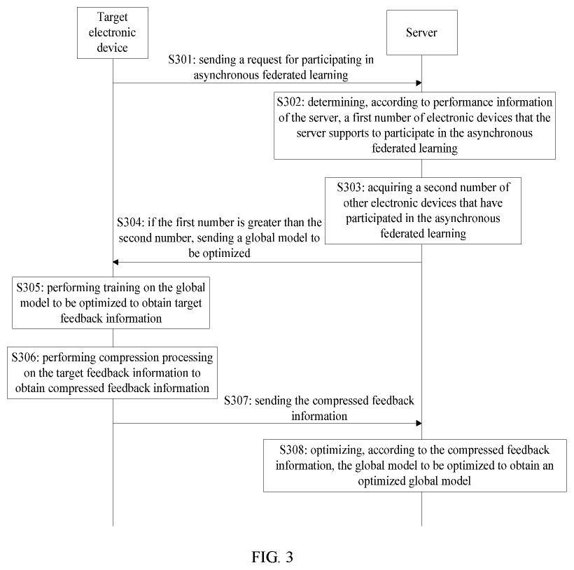

FIG. 3 is a schematic diagram according to a second embodiment of the present disclosure. As shown in FIG. 3, a method for asynchronous federated learning according to the embodiment of the present disclosure includes:

S301, a target electronic device sends a request for participating in the asynchronous federated learning to a server.

It should be understood that, for the sake of redundant statements, the technical features in the present embodiment that are the same as those in the foregoing embodiments will not be described in the present embodiment again.

In related art, it is generally a server that sends a training task to an electronic device, for example, the server sends a training task to a target electronic device, so that the target electronic device can participate in asynchronous federated learning. However, in the present embodiment, an electronic device may initiatively send a request for participating in the asynchronous federated learning to the server, such as the request initiated by the target electronic device in the present embodiment for participating in the asynchronous federated learning.

In the present embodiment, the electronic device initiatively requests to participate in the asynchronous federated learning, which can achieve technical effects of diversity and flexibility of the asynchronous federated learning.

In some embodiments, the electronic device may send the request for participating in the asynchronous federated learning to the server based on operating states and remaining resources of the electronic device.

In one example, if the operating state of the target electronic device is an idle state, the target electronic device sends the request for participating in the asynchronous federated learning to the server.

The idle state refers to a state in which the target electronic device has no running task or pending task. The target electronic device, when in its idle state, initiates the request for participating in the asynchronous federated learning to the server. Therefore, it is possible to effectively avoid a disadvantage that the target electronic device is unavailable, so that the target electronic device can participate in the asynchronous federated learning in a relatively efficient manner, thereby achieving technical effects of improving reliability and effectiveness of the asynchronous federated learning.

In another example, the target electronic device, when its remaining resources exceed a preset resource threshold, may send the request for participating in the asynchronous federated learning to the server.

The resource threshold can be determined based on demands, record histories, experiments and others.

For example, for a scenario where a relatively high requirement is imposed on the asynchronous federated learning, the resource threshold can be relatively large, so that the target electronic device has sufficient resources to participate in the asynchronous federated learning, thereby improving efficiency of the asynchronous federated learning; for a scenario where a relatively low requirement is imposed on the asynchronous federated learning, the resource threshold can be relatively small to avoid a waste of resources.

In yet another example, when the target electronic device has sufficient power, it may send the request for participating in the asynchronous federated learning to the server.

Having sufficient power may be interpreted as including at least two dimensions of content, where one dimension of content is to have sufficient processor resources, and the other dimension of content is to have sufficient power supply.

That is, the target electronic device, when having processor resources and/or power supply to support its participation in the asynchronous federated learning, can send the request for participating in the asynchronous federated learning to the server.

S302, the server determines, according to performance information of the server, a first number of electronic devices that the server supports to participate in the asynchronous federated learning.

In some embodiments, the performance information includes a load capacity; S302 may include:

determining, according to the load capacity, a number of electronic devices for which the asynchronous federated learning has a convergence speed reaching a preset speed threshold,

where the number of electronic devices for which the preset speed threshold is reached is determined as the first number.

Similarly, the speed threshold can be determined based on demands, record histories, experiments and others, which is not limited in the present embodiment.

In the present embodiment, by determining the first number in conjunction with the convergence speed, it is possible to avoid a disadvantage that the asynchronous federated learning has a slow convergence speed, thereby achieving technical effects of improving efficiency of the asynchronous federated learning.

In some embodiments, N electronic devices are included in an environment of the asynchronous federated learning; the determining, according to the load capacity, the number of electronic devices for which the asynchronous federated learning has the convergence speed reaching the preset speed threshold includes the following steps.

Step 1, determining, according to the load capacity, a convergence speed at which the N electronic devices participate in the asynchronous federated learning.

Exemplarily, when the load capacity of the server is determined, it is possible to determine the convergence speed of the asynchronous federated learning when the N electronic devices all participate in the asynchronous federated learning, that is, the convergence speed of the optimized global model that is obtained by the server.

For example, it is possible to determine, when the N electronic devices participate in the asynchronous federated learning, a time of the optimized global model is obtained, and determine the convergence speed based on that time.

Step 2, if the convergence speed at which the N electronic devices participate in the asynchronous federated learning is less than the preset speed threshold, determining, according to the load capacity, a convergence speed at which (N−M) electronic devices participate in the asynchronous federated learning, where 1≤M<N;

analogously till the number of electronic devices for which the asynchronous federated learning has the convergence speed reaching the preset speed threshold is obtained.

In conjunction with the above analysis, if a predicted convergence speed at which the N electronic devices participate in the asynchronous federated learning is relatively small and cannot reach the speed threshold, it means that the convergence speed is low; then the number of electronic devices participating in the asynchronous federated learning can be reduced, and a convergence speed at which a reduced number of electronic devices participate in the asynchronous federated learning can be predicted, analogously till the first number is obtained.

For example, when M takes a value of 1, comprehensibly, the electronic devices participating in the federated learning are reduced by one successively till the first number is obtained.

In the present embodiment, the first number is determined by the load capacity in combination with the sequential recursion, so that the determined first number can have relatively high accuracy and reliability, thereby effectively guaranteeing the convergence speed of the asynchronous federated learning, and achieving technical effects of improving efficiency of the asynchronous federated learning.

In other embodiments, the first number can be determined in conjunction with a preset hyper-parameter C. The preset hyper-parameter is used to represent a ratio of electronic devices that can meet a requirement for the convergence speed of the asynchronous federated learning to the N electronic devices, e.g., 10%, that is, when [N*10%] electronic devices participate in the asynchronous federated learning, the requirement for the convergence speed of the asynchronous federated learning can be met so as to avoid a disadvantage that the asynchronous federated learning has a low convergence speed.

Exemplarily, the preset hyper-parameter can be determined based on experience, record histories, experiments and others, or the preset hyper-parameter can be determined in conjunction with the load capacity of the server, which is not limited in the present embodiment.

S303, the server acquires a second number of other electronic devices that have participated in the asynchronous federated learning.

S304, if the first number is greater than the second number, the server sends a global model to be optimized to the target electronic device.

The global model to be optimized is obtained by the server from an initialization process.

Accordingly, the target electronic device receives the global model to be optimized sent by the server.

S305, the target electronic device performs training on the global model to be optimized to obtain target feedback information.

The target electronic device performing the training on the global model to be optimized can be interpreted as a process of obtaining a local model in conjunction with the global model to be optimized.

Exemplarily, the target electronic device includes a sample data set (also termed as a local data set) for participation of the asynchronous federated learning, and performs, based on the local data set, training on the global model to be optimized to obtain a local model. Correspondingly, the target feedback information may include model parameters of the local model.

It should be understood that a way in which the electronic device performs training on the global model to be optimized is not limited in the present embodiment, for example, an implementation is possible based on a loss function and iterative training.

In some embodiments, S305 may include the following steps.

Step 1, acquiring difference information of respective pieces of sample data in a sample data set for training the global model to be optimized.

Exemplarily, the sample data set includes pieces of sample data, and the quantity of the sample data may be determined based on demands, record histories, experiments and others, which is not limited in the present embodiment.

The difference information may represent data heterogeneity of the sample data set.

Exemplarily, the difference information may be interpreted as average difference information of the pieces of sample data, or as difference information between sample data with the largest difference.

Step 2, performing, according to the difference information and the sample data set, training on the global model to be optimized to the target feedback information.

In the present embodiment, by means of obtaining the target feedback information in conjunction with the difference information (that is, the data heterogeneity), it is possible to avoid, as many as possible, influences of the data heterogeneity on the training of the global model to be optimized, thereby allowing the convergence of the training to be more stable, and thus obtaining more reliable target feedback information.

In some embodiments, Step 2 may include the following sub-steps.

Sub-step 1, performing, according to the difference information, regularization processing on the global model to be optimized to obtain a processed global model.

Exemplarily, Sub-step 1 may include: determining, according to the difference information, a regularization weight parameter for training the global model to be optimized, and performing, according to the regularization weight parameter, the regularization processing on the global model to be optimized to obtain the processed global model.

In the present embodiment, by means of determining the regularization weight parameter in conjunction with the difference information and performing the regularization processing based on the regularization weight parameter, it is possible to achieve technical effects of improving validity and reliability of the regularization processing.

Sub-step 2, performing, according to the sample data set, training on the processed global model to obtain the target feedback information.

Exemplarily, the target feedback information is an updated local model, and the updated local model can be determined based on Equation 1 as follows:

$${min}_{w ∈ {R}^{d}} {E}_{x k} ∼ {D}_{k} [ {f}_{k} ( w ; {x}_{k} ) ] + \frac{μ}{2} {‖ w - {w}^{t} ‖}^{2}$$

where xₖ is sample data in the sample data set of the target electronic device, Dₖ[fₖ(w; xₖ)] is predicted loss information, μ is a regularization weight parameter, w is an updated local model, and w^{t} is a pre-updated local model.

In the present embodiment, the regularization weight parameter μ can be understood as a penalty term for obtaining the updated local model, so as to effectively limit negative impacts of data heterogeneity on a training process. The local update can be limited in such a manner that it is more likely to be close to the global model to be optimized that is received by the target electronic device, which is conducive to reducing the impacts of data heterogeneity, so that the convergence of the updated local model is more stable, thereby achieving technical effects of improving effectiveness and reliability of the asynchronous federated learning.

In some embodiments, the target feedback information includes a timestamp, the timestamp is used to represent the number of learning rounds of the asynchronous federated learning; and the timestamp is used to obtain the optimized global model.

Exemplarily, when receiving the global model to be optimized sent by the server, the target electronic device determines the number of learning rounds for training the global model to be optimized.

Carrying a timestamp in the target feedback information can be used to mark which round of asynchronous federated learning the target feedback information corresponds to, so that when the server determines the optimized global model in conjunction with the timestamp, it is possible to achieve technical effects that the information for determining the optimized global model has strong pertinence and reliability.

S306, the target electronic device performs compression processing on the target feedback information to obtain compressed feedback information.

Transmission resources of the compressed feedback information are less in number than transmission resources of the target feedback information.

When the target electronic device sends information to the server, a certain amount of transmission resources are to be consumed, that is, the target electronic device needs to send the information to the server based on the transmission resources. In order to save the transmission resources, the target feedback information can be compressed, and transmission resources for the target electronic device to transmit the compressed feedback information are less in number than transmission resources for the electronic device to transmit the target feedback information, thereby achieving technical effects of saving transmission resources, improving transmission efficiency, that is, greatly reducing traffic pressure, and improving communication efficiency.

In some embodiments, the compression processing includes quantization compression processing; the performing the compression processing on the target feedback information to obtain the compressed feedback information includes:

acquiring a number of bits of the target feedback information, and performing the quantization compression processing on the target feedback information to obtain the compressed feedback information,

where the number of bits of the compressed feedback information is less than the number of bits of the target feedback information.

Exemplarily, the number of bits of the target feedback information may be 32. If the target feedback information is a 32-bit floating point number, the target feedback information of the 32-bit floating point number can be compressed into compressed feedback information of an 8-bit floating point number.

In the present embodiment, through the quantization compression processing, convenience and rapidness of the compression processing can be realized, thereby achieving technical effects of improving communication efficiency and reducing traffic pressure.

In other embodiments, the target feedback information includes a plurality of sets of model parameters; the compression processing includes sparse compression processing; the performing the compression processing on the target feedback information to obtain the compressed feedback information includes the following steps.

Step 1, extracting at least one set of model parameters from the plurality of sets of model parameters, where the at least one set of model parameters is less in number than the plurality of sets of model parameters.

Step 2, generating a sparse vector corresponding to the at least one set of model parameters, where the compressed feedback information includes the sparse vector.

Exemplarily, a set of model parameters is selected from the respective sets of model parameters, and a sparse vector corresponding to the set of model parameters is generated.

In the present embodiment, by means of performing compression processing on the target feedback information in conjunction with the sparse vector, it is possible to achieve technical effects of improving reliability and effectiveness of compression.

Moreover, it can be seen from the above analysis that a method of quantization compression processing can be used to compress the target feedback information, or a method of sparse compression processing can also be used to compress the target feedback information. Certainly, also a method of “quantization compression+sparse compression” processing can be used to compress the target feedback information, so as to achieve technical effects of improving flexibility and diversity of the compression processing.

S307, the target electronic device sends the compressed feedback information to the server.

S308, the server optimizes, according to the compressed feedback information, the global model to be optimized to obtain an optimized global model.

In some embodiments, S308 may include the following steps.

Step 1, acquiring from a memory of the server, according to the compressed target feedback information, feedback information that is fed back by the other electronic devices and that is obtained from training on the global model to be optimized.

Exemplarily, in conjunction with the above analysis, if other electronic devices have participated in the asynchronous federated learning, the other electronic devices will also obtain corresponding feedback information and transmit the feedback information to the server. The server then can store the feedback information transmitted by the other electronic devices into its memory, and extract, upon reception of the compressed feedback information, the feedback information transmitted by the other electronic devices from the memory.

Step 2, optimizing, according to the compressed feedback information and the feedback information of the other electronic devices, the global model to be optimized to obtain the optimized global model.

It is worth mentioning that, in some embodiments, each time the server receives feedback information transmitted by an edge device, the server will optimize the global model to be optimized according to the feedback information. However, the use of this method may easily lead to a disadvantage that the optimized global model has a large deviation, whereas the use of the method according to Step 1 and Step 2 as described above is equivalent to provision of a caching mechanism in which persistent negative impacts of the optimized global model can be reduced and technical effects of improving accuracy of the optimized global model can be achieved.

It can be seen from the above analysis that, in some embodiments, the target feedback information may include a timestamp, and the timestamp is used to represent the number of learning rounds of the asynchronous federated learning. That is, the compressed feedback information includes a timestamp.

Accordingly, the acquiring from the memory of the server, according to the compressed feedback information, the feedback information that is fed back by the other electronic devices and that is obtained from the training on the global model to be optimized includes: acquiring, from the memory of the server, feedback information of the other electronic devices that have a same timestamp as the target electronic device.

Exemplarily, in conjunction with the above analysis and FIG. 2, if the target electronic device is the electronic device 1, the timestamp in the compressed feedback information of the electronic device 1 is a timestamp a, in the memory, the timestamp of the feedback information transmitted by the electronic device 2 is the timestamp a, and the timestamp of the feedback information transmitted by the electronic device N is also the timestamp a, then the server acquires, from its memory, all pieces of feedback information having the timestamp a, and optimizes, according to the acquired feedback information, the global model to be optimized to obtain an optimized global model.

In the present embodiment, by means of determining, in conjunction with the timestamp, the feedback information for optimizing the global model to be optimized, it is possible to improve efficiency and accuracy of determining the feedback information, thereby achieving technical effects of improving reliability of the optimized global model.

In some embodiments, it is also possible to optimize, in conjunction with information relevant to a memory capacity, the global model to be optimized to obtain the optimized global model.

Exemplarily, after the feedback information having the same timestamp as the compressed feedback information is acquired, an occupancy capacity of the compressed feedback information and the acquired feedback information (that is, the feedback information of the other electronic devices) in the memory may be determined. If the occupancy capacity reaches a preset capacity threshold, optimizing, according to the compressed feedback information and the acquired feedback information, the global model to be optimized to obtain the optimized global model.

Similarly, the capacity threshold may be determined based on demands, record histories, experiments and others, which is not limited in the present embodiment.

Exemplarily, in conjunction with the above analysis, it is possible to determine an occupancy capacity of the feedback information in the memory whose timestamp is the timestamp a in the memory, and compare the occupancy capacity with the capacity threshold, if the occupancy capacity reaches a capacity threshold, acquire from the memory the feedback information having the timestamp a, and optimize, according to the feedback information having the timestamp a, the global model to be optimized to obtain the optimized global model.

Otherwise, if the occupancy capacity does not reach the capacity threshold, the server continues to accept feedback information of other electronic devices and performs a capacity comparison operation, and the server optimizes the global model to be optimized to obtain the optimized global model, until the occupancy capacity of the feedback information having the timestamp a reaches the capacity threshold.

In the present embodiment, by means of optimizing, in conjunction with the information relevant to the memory capacity, the global model to be optimized to obtain the optimized global model, it is possible to further improve the convergence speed of the asynchronous federated learning, that is, achieving technical effects of improving the speed and timeliness of the asynchronous federated learning.

In some embodiments, a capacity parameter γ may be set, and γϵ(0,1), if the total capacity of the cache is N (that is, the memory can accommodate the feedback information transmitted by the N electronic devices), then the capacity threshold=N*γ.

Similarly, in the present embodiment, the capacity parameter γ may also be determined in conjunction with the convergence speed or other demands. For a specific implementation method, reference may be made to principles for setting the preset hyper-parameter C in the foregoing embodiments, and details will not be described here again.

In some embodiments, it is also possible to optimize, according to staleness information of the global model to be optimized, the global model to be optimized to obtain the optimized global model.

The staleness information is also termed as hysteresis information. Relatively speaking, the larger the hysteresis value represented by the hysteresis information, the slower the convergence speed of the model during optimization.

In the present embodiment, by means of optimizing in conjunction with the staleness information, it is possible to improve the convergence speed of the model during optimization, thereby achieving technical effects of improving the speed of optimization.

Accordingly, the optimizing, according to the compressed feedback information, the global model to be optimized to obtain the optimized global model includes the following steps.

Step 1, acquiring records on optimization histories obtained by optimizing the global model to be optimized, and generating, according to the records on optimization histories, staleness information on every two adjacent times of optimizations of the global model to be optimized.

It can be seen from the above analysis that the model optimization is an on-going process. After a previous round of optimization is completed, a next round of optimization will begin. Therefore, the “adjacent times” in this step can be interpreted as adjacent rounds of optimizations, e.g., the current round and the next round, the previous round and the current round, etc.

Step 2, optimizing, according to respective pieces of staleness information and the compressed feedback information, the global model to be optimized to obtain the optimized global model.

In some embodiments, Step 2 may include the following sub-steps.

Sub-step 1, determining respective staleness weights corresponding to the respective pieces of staleness information, and performing a weighted average calculation on the respective pieces of staleness information to obtain average staleness information.

Sub-step 2, optimizing, according to the average staleness information, the respective staleness weights and the compressed feedback information, the global model to be optimized to obtain the optimized global model.

It is worth mentioning that, in the present embodiment, by means of determining the respective staleness weights and obtaining the optimized global model based on the respective staleness weights, it is possible to further improve the convergence speed of the asynchronous federated learning, thereby achieving technical effects of improving efficiency of the optimized global model obtained.

In some embodiments, Sub-step 2 may include the following refinement steps.

Refinement step 1, acquiring feedback information transmitted by the other electronic devices participating in the asynchronous federated learning.

The feedback information transmitted by the other electronic devices participating in the asynchronous federated learning and the compressed feedback information include respective corresponding updated model parameters.

Exemplarily, the feedback information transmitted by the other electronic devices participating in the asynchronous federated learning includes updated model parameters, and the compressed feedback information includes updated model parameters.

Refinement step 2, determining an average updated model parameter, according to the respective corresponding updated model parameters included in the feedback information transmitted by the other electronic devices participating in the asynchronous federated learning and the target feedback information.

Refinement step 3, optimizing, according to the average staleness information, the respective staleness weights and the average updated model parameter, the global model to be optimized to obtain the optimized global model.

Exemplarily, if the parameter of the global model in the t-th round on the server is wₜ, the target electronic device is an electronic device k, the compressed feedback information transmitted by the electronic device k to the server (specifically, the compressed updated model parameter) is wₖ^{h}^{ₖ}, and the timestamp is hₖ≤t, then the staleness information of the model to be optimized is t−hₖ , the staleness weight can be determined by Equation 2 as follows:

S(t−hₖ)=(t−hₖ+1)^{-a}, a>0

where a is a hyper-parameter for the staleness weight.

In some embodiments, each piece of feedback information includes an updated model parameter. If, in conjunction with the above analysis, K=N*γ pieces of feedback information in the memory of the server include respective corresponding updated model parameters, then it is possible to determine an average updated model parameter of the respective pieces of feedback information, and obtain the optimized global model in conjunction with the staleness weights and the average updated model parameter.

Exemplarily, the average updated model parameter u can be determined according to Equation 3 as follows:

$$u = \frac{{\sum }_{k = 1}^{K} S ( {t - h}_{k} ) \frac{{n}_{k}}{n} {w}_{k}^{{n}_{k}}}{{\sum }_{k = 1}^{K} S ( t - {h}_{k} ) \frac{{n}_{k}}{n}} = \frac{{\sum }_{k = 1}^{K} S ( t - {h}_{k} ) {n}_{k} {w}_{k}^{{n}_{k}}}{{\sum }_{k = 1}^{K} S ( t - {h}_{k} ) {n}_{k}} .$$

The average staleness information can be determined according to Equation 4 as follows:

$$δ = \frac{1}{K} {\sum }_{k = 1}^{K} ( t - {h}_{k} )$$

Correspondingly, the optimized global model w^{t+1} can be determined according to Equation 5 as follows:

w^{t+1}=a^{t}u+(1−a^{t})w^{t}

where a^{t} is the mixing weight of the t-th round, a^{t}=β*S(δ), β is the preset mixing hyper-parameter, βϵ(0,1].

In the present embodiment, by means of obtaining the optimized global model in conjunction with the average staleness information, the respective staleness weights and the average updated model parameter, it is possible to achieve technical effects of further improving reliability and accuracy of the optimized global model obtained.

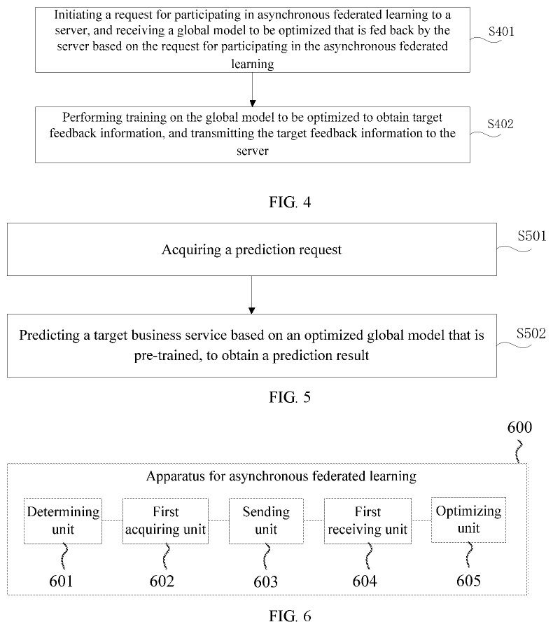

FIG. 4 is a schematic diagram according to a third embodiment of the present disclosure. A method for asynchronous federated learning according to the embodiment of the present disclosure can be applied to an electronic device. As shown in FIG. 4, the method includes:

S401, initiating a request for participating in the asynchronous federated learning to a server, and receiving a global model to be optimized that is fed back by the server based on the request for participating in the asynchronous federated learning.

The global model to be optimized is received when a first number is greater than a second number, the first number is the number of electronic devices that the server supports to participate in the asynchronous federated learning and the first number is determined according to performance information of the server, and the second number is an acquired number of other electronic devices that have participated in the asynchronous federated learning.

S402, performing training on the global model to be optimized to obtain target feedback information, and transmitting the target feedback information to the server.

The target feedback information is used to optimize the global model to be optimized to obtain an optimized global model.

In some embodiments, S402 includes the following steps.

Step 1, acquiring difference information of respective pieces of sample data in a sample data set for training the global model to be optimized.

Step 2, performing, according to the difference information and the sample data set, training on the global model to be optimized to obtain the target feedback information.

In some embodiments, Step 2 includes the following sub-steps.

Sub-step 1, performing, according to the difference information, regularization processing on the global model to be optimized to obtain a processed global model.

In some embodiments, Sub-step 1 includes: determining, according to the difference information, a regularization weight parameter for training the global model to be optimized, and performing, according to the regularization weight parameter, the regularization processing on the global model to be optimized to obtain the processed global model.

Sub-step 2: performing, according to the sample data set, training on the processed global model to obtain the target feedback information.

In some embodiments, after the global model to be optimized is trained to obtain the target feedback information, the method further includes: performing compression processing on the target feedback information to obtain compressed feedback information.

Transmission resources of the compressed feedback information are less in number than transmission resources of the target feedback information.

In some embodiments, the compression processing includes quantization compression processing; the performing the compression processing on the target feedback information to obtain the compressed feedback information includes: acquiring a number of bits of the target feedback information, and performing the quantization compression processing on the target feedback information according to the number of bits of the target feedback information to obtain the compressed feedback information.

The number of bits of the compressed feedback information is less than the number of bits of the target feedback information.

In some embodiments, the target feedback information includes a plurality of sets of model parameters; the compression processing includes sparse compression processing; the performing the compression processing on the target feedback information to obtain the compressed feedback information includes the following steps:

Step 1, extracting at least one set of model parameters from the plurality of sets of model parameters, where the at least one set of model parameters is less in number than the plurality of sets of model parameters;

Step 2, generating a sparse vector corresponding to the at least one set of model parameters, where the compressed feedback information includes the sparse vector.

In some embodiments, the target feedback information includes a timestamp, the timestamp is used to represent the number of learning rounds of the asynchronous federated learning; and the timestamp is used to obtain the optimized global model.

In some embodiments, the timestamp is used to acquire, from a memory of the server, feedback information of the other electronic devices that have a same timestamp as the target electronic device; the target feedback information and the feedback information of the other electronic devices are used to obtain the optimized global model.

FIG. 5 is a schematic diagram according to a fourth embodiment of the present disclosure. As shown in FIG. 5, a method for predicting a business service includes:

S501, acquiring a prediction request.

The prediction request is used to request prediction of a target business service.

Exemplarily, the execution subject of the present embodiment may be an apparatus for predicting a business service (hereinafter referred to as a predicting apparatus for short). The predicting apparatus may be a server (such as a local server, or a cloud server, or a server cluster), or may be a terminal device, or an electronic device (such as the edge device in the foregoing embodiments), or a processor, or a chip, etc., which is not limited in the present embodiment.

It should be understood that the target business service may include prediction services in different scenarios and fields, that is, the target business service may vary with different application scenarios or different fields. For example, in an image recognition scenario, the target business service may be a face recognition service, and the corresponding prediction service is a face predicting service; for another example, in the financial field, the target business service may be a credibility predicting service, such as a service for predicting user credibility, and so on; and enumerations will be omitted here.

S502, predicting the target business service based on an optimized global model that is pre-trained, to obtain a prediction result.

The optimized global model is obtained based on the method of any one of the foregoing embodiments.

It is worth mentioning that, in conjunction with the above analysis, the optimized global model in the present embodiment has high accuracy and reliability. Therefore, when the target business service is predicted in conjunction with the optimized global model, it is also possible to achieve technical effect of improving accuracy and reliability of the prediction result.

FIG. 6 is a schematic diagram according to a fifth embodiment of the present disclosure. An apparatus for asynchronous federated learning according to the present embodiment can be applied to a server. As shown in FIG. 6, the apparatus 600 for the asynchronous federated learning includes:

a determining unit 601, configured to: in response to a request for participating in the asynchronous federated learning sent by a target electronic device, determine, according to performance information of the server, a first number of electronic devices that the server supports to participate in the asynchronous federated learning;

a first acquiring unit 602, configured to acquire a second number of other electronic devices that have participated in the asynchronous federated learning;

a sending unit 603, configured to: if the first number is greater than the second number, send a global model to be optimized to the target electronic device;

a first receiving unit 604, configured to receive target feedback information which is obtained by the target electronic device from training on the global model to be optimized; and

an optimizing unit 605, configured to optimize, according to the target feedback information, the global model to be optimized to obtain an optimized global model.

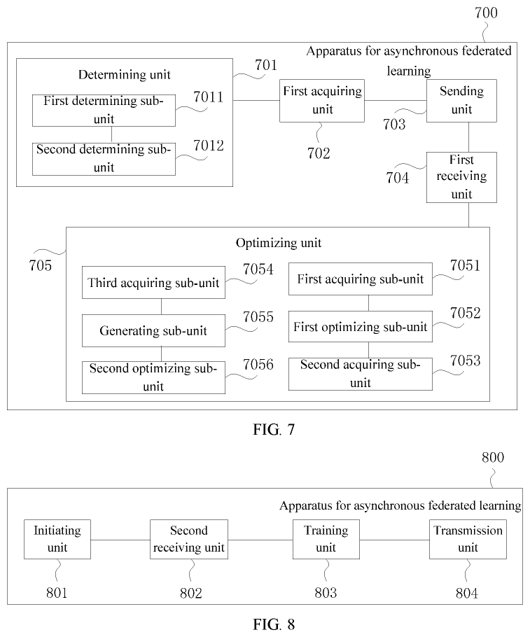

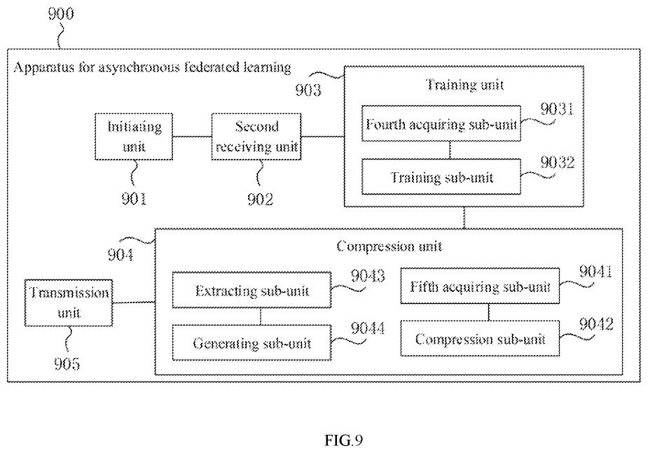

FIG. 7 is a schematic diagram according to a sixth embodiment of the present disclosure. An apparatus for asynchronous federated learning according to the present embodiment can be applied to a server. As shown in FIG. 7, the apparatus 700 for the asynchronous federated learning includes:

a determining unit 701, configured to: in response to a request for participating in the asynchronous federated learning sent by a target electronic device, determine, according to performance information of the server, a first number of electronic devices that the server supports to participate in the asynchronous federated learning.

In some embodiments, the performance information includes a load capacity; the determining unit 701 is configured to determine, according to the load capacity, a number of electronic devices for which the asynchronous federated learning has a convergence speed reaching a preset speed threshold, where the number of electronic devices for which the preset speed threshold is reached is determined as the first number.

In some embodiments, N electronic devices are included in an environment of the asynchronous federated learning; the determining unit 701 includes:

a first determining sub-unit 7011, configured to determine, according to the load capacity, a convergence speed at which the N electronic devices participate in the asynchronous federated learning;

a second determining sub-unit 7012, configured to: if the convergence speed at which the N electronic devices participate in the asynchronous federated learning is less than the preset speed threshold, determine, according to the load capacity, a convergence speed at which (N-M) electronic devices participate in the asynchronous federated learning, where 1≤M<N;

analogously till the number of electronic devices for which the asynchronous federated learning has the convergence speed reaching the preset speed threshold is obtained.

The apparatus 700 further includes:

a first acquiring unit 702, configured to acquire a second number of other electronic devices that have participated in the asynchronous federated learning;

a sending unit 703, configured to: if the first number is greater than the second number, send a global model to be optimized to the target electronic device;

a first receiving unit 704, configured to receive target feedback information which is obtained by the target electronic device from training on the global model to be optimized; and

an optimizing unit 705, configured to optimize, according to the target feedback information, the global model to be optimized to obtain an optimized global model.

In some embodiments, the optimizing unit 705 includes:

a first acquiring sub-unit 7051, configured to acquire from a memory of the server, according to the target feedback information, feedback information that is fed back by the other electronic devices and that is obtained from training on the global model to be optimized; and

a first optimizing sub-unit 7052, configured to optimize, according to the target feedback information and the feedback information of the other electronic devices, the global model to be optimized to obtain the optimized global model.

In some embodiments, the target feedback information includes a timestamp, the timestamp is used to represent a number of learning rounds of the asynchronous federated learning; and the first acquiring sub-unit 7051 is configured to acquire, from the memory of the server, feedback information of the other electronic devices that have a same timestamp as the target electronic device.

In some embodiments, the optimizing unit 705 further includes:

a second acquiring sub-unit 7053, configured to acquire the target feedback information and an occupancy capacity of the feedback information of the other electronic devices in the memory;

the first optimizing sub-unit 7052 is configured to: if the occupancy capacity reaches a preset capacity threshold, optimize, according to the target feedback information and the feedback information of the other electronic devices, the global model to be optimized to obtain the optimized global model.

In some embodiments, the optimizing unit 705 includes:

a third acquiring sub-unit 7054, configured to acquire records on optimization histories obtained by optimizing the global model to be optimized;

a generating sub-unit 7055, configured to generate, according to the records on optimization histories, staleness information on every two adjacent times of optimizations of the global model to be optimized; and

a second optimizing sub-unit 7056, configured to optimize, according to respective pieces of staleness information and the target feedback information, the global model to be optimized to obtain the optimized global model.

In some embodiments, the second optimizing sub-unit 7056 includes:

a determining module, configured to determine respective staleness weights corresponding to the respective pieces of staleness information;

a calculating module, configured to perform a weighted average calculation on the respective pieces of staleness information to obtain average staleness information; and

an optimizing module, configured to optimize, according to the average staleness information, the respective staleness weights and the target feedback information, the global model to be optimized to obtain the optimized global model.

In some embodiments, the optimizing module includes:

an acquiring sub-module, configured to acquire feedback information transmitted by the other electronic devices participating in the asynchronous federated learning, where the feedback information transmitted by the other electronic devices participating in the asynchronous federated learning and the target feedback information include respective corresponding updated model parameters;

a first determining sub-module, configured to determine an average updated model parameter, according to the respective corresponding updated model parameters included in the feedback information transmitted by the other electronic devices participating in the asynchronous federated learning and the target feedback information; and

an optimizing sub-module, configured to optimize, according to the average staleness information, the respective staleness weights and the average updated model parameter, the global model to be optimized to obtain the optimized global model.

In some embodiments, the target feedback information is obtained by acquiring difference information of respective pieces of sample data in a sample data set for training the global model to be optimized, and performing, according to the difference information and the sample data set, training on the global model to be optimized.

In some embodiments, the target feedback information is obtained by performing, according to the difference information, regularization processing on the global model to be optimized to obtain a processed global model, and performing, according to the sample data set, training on the processed global model.

In some embodiments, the processed global model is obtained by determining, according to the difference information, a regularization weight parameter for training the global model to be optimized, and performing, according to the regularization weight parameter, the regularization processing on the global model to be optimized.

In some embodiments, the target feedback information is compressed feedback information obtained by compression processing, and transmission resources of the compressed feedback information are less in number than transmission resources of pre-compression feedback information.

In some embodiments, the compression processing includes quantization compression processing; the compressed feedback information is acquired from a number of bits of the pre-compression feedback information, the pre-compression feedback information is subject to the quantization compression processing according to the number of bits of the pre-compression feedback information to obtain the compressed feedback information, where a number of bits of the compressed feedback information is less than the number of bits of the pre-compression feedback information.

In some embodiments, the pre-compression feedback information includes a plurality of sets of model parameters; the compression processing includes sparse compression processing; the compressed feedback information is obtained by extracting at least one set of model parameters from the plurality of sets of model parameters, where the at least one set of model parameters is less in number than the plurality of sets of model parameters, and generating a sparse vector corresponding to the at least one set of model parameters.

FIG. 8 is a schematic diagram according to a seventh embodiment of the present disclosure. An apparatus for asynchronous federated learning according to the present embodiment can be applied to an electronic device. As shown in FIG. 8, the apparatus 800 for the asynchronous federated learning includes:

an initiating unit 801, configured to initiate a request for participating in the asynchronous federated learning to a server;

a second receiving unit 802, configured to receive a global model to be optimized that is fed back by the server based on the request for participating in the asynchronous federated learning, where the global model to be optimized is received when a first number is greater than a second number, the first number is a number of electronic devices that the server supports to participate in the asynchronous federated learning determined according to performance information of the server, and the second number is an acquired number of other electronic devices that have participated in the asynchronous federated learning;

a training unit 803, configured to perform training on the global model to be optimized to obtain target feedback information; and

a transmission unit 804, configured to transmit the target feedback information to the server, where the target feedback information is used to optimize the global model to be optimized to obtain an optimized global model.

FIG. 9 is a schematic diagram according to an eighth embodiment of the present disclosure. An apparatus for asynchronous federated learning according to the present embodiment can be applied to an electronic device. As shown in FIG. 9, the apparatus 900 for the asynchronous federated learning includes:

an initiating unit 901, configured to initiate a request for participating in the asynchronous federated learning to a server;

a second receiving unit 902, configured to receive a global model to be optimized that is fed back by the server based on the request for participating in the asynchronous federated learning, where the global model to be optimized is received when a first number is greater than a second number, the first number is a number of electronic devices that the server supports to participate in the asynchronous federated learning determined according to performance information of the server, and the second number is an acquired number of other electronic devices that have participated in the asynchronous federated learning; and

a training unit 903, configured to perform training on the global model to be optimized to obtain target feedback information.

In some embodiments, the training unit 903 includes:

a fourth acquiring sub-unit 9031, configured to acquire difference information of respective pieces of sample data in a sample data set for training the global model to be optimized; and

a training sub-unit 9032, configured to perform, according to the difference information and the sample data set, training on the global model to be optimized to obtain the target feedback information.

In some embodiments, the training sub-unit 9032 includes:

a processing module, configured to perform, according to the difference information, regularization processing on the global model to be optimized to obtain a processed global model; and

a training module, configured to perform, according to the sample data set, training on the processed global model to obtain the target feedback information.

In some embodiments, the processing module includes:

a second determining sub-module, configured to determine, according to the difference information, a regularization weight parameter for training the global model to be optimized; and

a processing sub-module, configured to perform, according to the regularization weight parameter, the regularization processing on the global model to be optimized to obtain the processed global model.

The apparatus 900 further includes:

a compression unit 904, configured to perform compression processing on the target feedback information to obtain compressed feedback information, where transmission resources of the compressed feedback information are less in number than transmission resources of the target feedback information.

In some embodiments, the compression processing includes quantization compression processing; the compression unit 904 includes:

a fifth acquiring sub-unit 9041, configured to acquire a number of bits of the target feedback information; and

a compression sub-unit 9042, configured to perform the quantization compression processing on the target feedback information according to the number of bits of the target feedback information to obtain the compressed feedback information, where a number of bits of the compressed feedback information is less than the number of bits of the target feedback information.

In some embodiments, the target feedback information includes a plurality of sets of model parameters; the compression processing includes sparse compression processing; the compression unit 904 includes:

an extracting sub-unit 9043, configured to extract at least one set of model parameters from the plurality of sets of model parameters, where the at least one set of model parameters is less in number than the plurality of sets of model parameters; and

a generating sub-unit 9044, configured to generate a sparse vector corresponding to the at least one set of model parameters, where the compressed feedback information includes the sparse vector.

In some embodiments, the target feedback information includes a timestamp, the timestamp is used to represent a number of learning rounds of the asynchronous federated learning; and the timestamp is used to obtain the optimized global model.

In some embodiments, the timestamp is used to acquire, from a memory of the server, feedback information of the other electronic devices that have a same timestamp as the target electronic device; the target feedback information and the feedback information of the other electronic devices are used to obtain the optimized global model.

The apparatus 900 further includes:

a transmission unit 905, configured to transmit the compressed feedback information to the server, where the compressed feedback information is used to optimize the global model to be optimized to obtain an optimized global model.

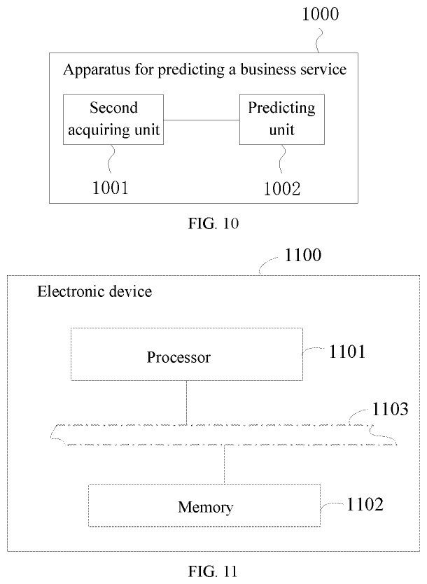

FIG. 10 is a schematic diagram according to a ninth embodiment of the present disclosure. As shown in FIG. 10, an apparatus 1000 for predicting a business service including:

a second acquiring unit 1001, configured to acquire a prediction request, where the prediction request is used to request prediction of a target business service; and

a predicting unit 1002, configured to predict the target business service based on an optimized global model that is pre-trained, to obtain a prediction result;

where the optimized global model is obtained based on the method of any one of the foregoing embodiments.

According to another aspect of the present disclosure, an embodiment of the present disclosure further provides a system for asynchronous federated learning, including: a server and an electronic device,

where the server includes the apparatus as described in the fifth embodiment and the sixth embodiment; and

the electronic device includes the apparatus as described in the seventh embodiment and the eighth embodiment.

FIG. 11 is a schematic diagram of a tenth embodiment according to the present disclosure. As shown in FIG. 11, an electronic device 1100 in the present disclosure may include: a processor 1101 and a memory 1102.

The memory 1102 is configured to store a program; the memory 1102 may include a volatile memory, e.g., a random access memory (abbreviated as RAM), such as a static random access memory (abbreviated as SRAM), a double data rate synchronous dynamic random access memory (abbreviated as DDR SDRAM), or the like; the memory may also include a non-volatile memory, such as a flash memory. The memory 1102 is configured to store a computer program (such as an application program, a functional module or the like for implementing the above-described methods), a computer instruction or the like. The above-described computer program, the computer instruction or the like can be stored in one or more memories 1102 in a partitioned manner. Moreover, the above-described computer program, the computer instruction, data or the like can be called by the processor 1101.

The computer program, the computer instruction or the like as described above can be stored in one or more memories 1102 in a partitioned manner. Moreover, the above-described computer program, the computer instruction or the like can be called by the processor 1101.

The processor 1101 is configured to execute the computer program stored in the memory 1102, so as to implement various steps in the methods involved in the forgoing embodiments.

For details, reference may be made to relevant descriptions in the foregoing method embodiments.

The processor 1101 and the memory 1102 may be independent structures, or may be an integrated structure with all of them being integrated together. When the processor 1101 and the memory 1102 are independent structures, the memory 1102 and the processor 1101 can be coupled and connected via a bus 1103.

The electronic device in the present embodiment can execute the technical solutions in the above methods; it has the same specific implementations and technical principles as the technical solutions in the above methods, which will not be described here again.

In the technical solutions of the present disclosure, the collection, storage, usage, processing, transmission, provision, publication and other applications of a user's personal information (such as sample data collection and the like) are in compliance with the provisions of relevant laws and regulations, and do not violate public order and moral.

According to embodiments of the present disclosure, the present disclosure also provides an electronic device, a readable storage medium, and a computer program product.

According to an embodiment of the present disclosure, the present disclosure also provides a computer program product, where the computer program product includes a computer program stored in a readable storage medium, at least one processor of an electronic device may read the computer program from the readable medium storage, and the at least one processor executes the computer program to enable the electronic device to execute the solution provided in any one of the aforementioned embodiments.

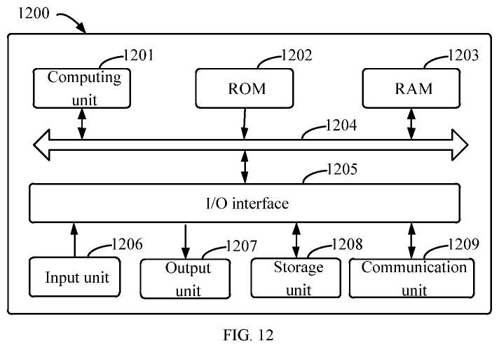

FIG. 12 shows a schematic block diagram illustrating an exemplary electronic device 1200 which can be used to implement an embodiment of the present disclosure. The electronic device is intended to represent various forms of digital computers, such as a laptop computer, a desktop computer, a workstation, a personal digital assistant, a server, a blade server, a mainframe computer and other suitable computers. The electronic device may also represent various forms of mobile apparatuses, such as a personal digital assistant, a cellular phone, a smart phone, a wearable device and other similar computing apparatuses. The components shown herein, their connections and relationships, and their functions are merely exemplary, and are not intended to limit the implementations of the present disclosure described and/or claimed herein.

As shown in FIG. 12, the device 1200 includes a computing unit 1201, which may perform various appropriate actions and processes according to a computer program stored in a read-only memory (ROM) 1202 or a computer program loaded from a storage unit 1208 to a random access memory (RAM) 1203. In the RAM 1203, various programs and data required for operations of the device 1200 may also be stored. The computing unit 1201, the ROM 1202 and the RAM 1203 are connected to each other through a bus 1204. An input/output (I/O) interface 1205 is also connected to the bus 1204.

Multiple components in the device 1200 are connected to the I/O interface 1205, and include: an input unit 1206, such as a keyboard, a mouse, etc.; an output unit 1207, such as various types of displays, speakers, etc.; the storage unit 1208, such as a magnetic disk, an optical disc, etc.; and a communication unit 1209, such as a network card, a modem, a wireless communication transceiver, etc. The communication unit 1209 allows the device 1200 to exchange information/data with other devices over a computer network such as Internet and/or various telecommunication networks.

The computing unit 1201 may be various general-purpose and/or special-purpose processing components with processing and computing capabilities. Some examples of the computing unit 1201 include, but are not limited to, central processing units (CPU), graphic processing units (GPU), various dedicated artificial intelligence (AI) computing chips, various computing units that run machine learning model algorithms, digital signal processors (DSP), and also any appropriate processors, controllers, microcontrollers, etc. The computing unit 1201 executes each method and process described above, e.g., a method for asynchronous federated learning and a method for predicting a business service. For example, in some embodiments, the method for the asynchronous federated learning and the method for predicting the business service can be implemented as computer software programs, which are tangibly contained in a machine-readable medium, such as the storage unit 1208. In some embodiments, part or entirety of the computer program may be loaded and/or installed into the device 1200 via the ROM 1202 and/or the communication unit 1209. When the computer program is loaded into the RAM 1203 and executed by the computing unit 1201, one or more steps of the method for the asynchronous federated learning and the method for predicting the business service as described above may be executed. Alternatively, in other embodiments, the computing unit 1201 may be configured to execute the method for the asynchronous federated learning and the method for predicting the business service, in any other suitable manner (for example, by means of firmware).

Various implementations of the system and technology described above herein may be implemented in digital electronic circuit systems, integrated circuit systems, field programmable gate arrays (FPGA), application specific integrated circuits (ASIC), application specific standard parts (ASSP), system-on-chips (SOC), complex programmable logic devices (CPLD), computer hardware, firmware, software, and/or a combination thereof. These various implementations may include: being implemented in one or more computer programs, where the one or more computer programs may be executed and/or interpreted on a programmable system including at least one programmable processor. The programmable processor may be a special-purpose or general-purpose programmable processor, can receive data and instructions from a storage system, at least one input apparatus and at least one output apparatus, and transmit the data and instructions to the storage system, the at least one input apparatus and the at least one output apparatus.

Program codes for implementing a method of the present disclosure can be written in one programming language or any combination of multiple programming languages. These program codes can be provided to a processor or a controller of a general-purpose computer, a special-purpose computer, or other programmable data processing apparatus, so that functions/operations specified in flowcharts and/or block diagrams are implemented when the program codes are executed by the processor or the controller. The program codes may be executed entirely on a machine, partly on a machine, partly executed on a machine and partly executed on a remote machine as an independent software package, or entirely executed on a remote machine or a server.

In the context of the present disclosure, the machine-readable medium may be a tangible medium, which may contain or store a program for an instruction execution system, apparatus, or device to use or to be used in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductive system, apparatus, or device, or any suitable combination of the foregoing. More specific examples of the machine-readable storage medium would include an electrically connected portable computer disk based on one or more wires, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

In order to provide interaction with users, the system and technology described herein can be implemented on a computer, where the computer has: a display apparatus for displaying information to users (for example, a CRT (cathode ray tube) or LCD (liquid crystal display) monitor); and a keyboard and a pointing apparatus (for example, a mouse or a trackball) through which the users can provide input to the computer. Other kinds of apparatuses can also be used to provide interaction with the users; for example, a feedback provided to the users may be any form of sensory feedback (for example, visual feedback, auditory feedback, or tactile feedback); and input from the users can be received in any form (including acoustic input, voice input, or tactile input).

The system and technology described herein can be implemented in a computing system that includes background components (for example, as a data server), or a computing system that includes middleware components (for example, an application server), or a computing system that includes front-end components (for example, a user computer with a graphical user interface or a web browser through which the user can interact with implementations of the system and technology described herein), or a computing system that includes any combination of such background components, middleware components or front-end components. The components of the system can be connected to each other through digital data communication in any form or medium (for example, a communication network). Examples of the communication network include: a local area network (LAN), a wide area network (WAN) and the Internet.

The computing system may include a client and a server. The client and server are generally far away from each other and usually interact through a communication network. A relationship between the client and the server is generated through computer programs running on corresponding computers and having a client-server relationship with each other. The server may be a cloud server, also known as a cloud computing server or a cloud host, which is a host product in a cloud computing service system to overcome defects of huge management difficulty and weak business scalability existing in a traditional physical host and a VPS service (“Virtual Private Server”, or “VPS” for short). The server may also be a server of a distributed system, or a server combined with a blockchain.

It should be understood that various forms of processes shown above may be used to reorder, add or delete steps. For example, the steps described in the present disclosure may be executed in parallel, sequentially or in a different order, as long as a desired result of the technical solution disclosed in the present disclosure can be achieved, and there is no limitation herein.

The aforementioned specific implementations do not constitute a limitation to the protection scope of the present disclosure. Persons skilled in the art should understand that various modifications, combinations, sub-combinations and substitutions may be made according to design requirements and other factors. Any modification, equivalent replacement and improvement, etc. made within the spirit and principle of the present disclosure shall be included in the protection scope of the present disclosure.

What is claimed is:

1. A method for asynchronous federated learning, applied to a server, comprising:
in response to a request for participating in the asynchronous federated learning sent by a target electronic device, determining, according to performance information of the server, a first number of electronic devices that the server supports to participate in the asynchronous federated learning, and acquiring a second number of other electronic devices that have participated in the asynchronous federated learning;
if the first number is greater than the second number, sending a global model to be optimized to the target electronic device, and receiving target feedback information which is obtained by the target electronic device from training on the global model to be optimized; and
optimizing, according to the target feedback information, the global model to be optimized to obtain an optimized global model.

2. The method according to claim 1, wherein the performance information comprises a load capacity; the determining, according to the performance information of the server, the first number of electronic devices that the server supports to participate in the asynchronous federated learning comprises:
determining, according to the load capacity, a number of electronic devices for which the asynchronous federated learning has a convergence speed reaching a preset speed threshold, wherein the number of electronic devices for which the preset speed threshold is reached is determined as the first number.

3. The method according to claim 2, wherein N electronic devices are comprised in an environment of the asynchronous federated learning; the determining, according to the load capacity, the number of electronic devices for which the asynchronous federated learning has the convergence speed reaching the preset speed threshold comprises:
determining, according to the load capacity, a convergence speed at which the N electronic devices participate in the asynchronous federated learning;
if the convergence speed at which the N electronic devices participate in the asynchronous federated learning is less than the preset speed threshold, determining, according to the load capacity, a convergence speed at which (N-M) electronic devices participate in the asynchronous federated learning, wherein 1≤M<N;
analogously till the number of electronic devices for which the asynchronous federated learning has the convergence speed reaching the preset speed threshold is obtained.

4. The method according to claim 1, wherein the optimizing, according to the target feedback information, the global model to be optimized to obtain the optimized global model comprises:
acquiring from a memory of the server, according to the target feedback information, feedback information that is fed back by the other electronic devices and that is obtained from training on the global model to be optimized; and
optimizing, according to the target feedback information and the feedback information of the other electronic devices, the global model to be optimized to obtain the optimized global model.

5. The method according to claim 4, wherein the target feedback information comprises a timestamp, the timestamp is used to represent a number of learning rounds of the asynchronous federated learning; and the acquiring from the memory of the server, according to the target feedback information, the feedback information that is fed back by the other electronic devices and that is obtained from the training on the global model to be optimized comprises:
acquiring, from the memory of the server, feedback information of the other electronic devices that have a same timestamp as the target electronic device.

6. The method according to claim 5, after the acquiring, from the memory of the server, the feedback information of the other electronic devices that have the same timestamp as the target electronic device, further comprising:
acquiring the target feedback information and an occupancy capacity of the feedback information of the other electronic devices in the memory;
the optimizing, according to the target feedback information and the feedback information of the other electronic devices, the global model to be optimized to obtain the optimized global model comprises:
if the occupancy capacity reaches a preset capacity threshold, optimizing, according to the target feedback information and the feedback information of the other electronic devices, the global model to be optimized to obtain the optimized global model.

7. The method according to claim 1, wherein the optimizing, according to the target feedback information, the global model to be optimized to obtain the optimized global model comprises:
acquiring records on optimization histories obtained by optimizing the global model to be optimized, and generating, according to the records on optimization histories, staleness information on every two adjacent times of optimizations of the global model to be optimized; and
optimizing, according to respective pieces of staleness information and the target feedback information, the global model to be optimized to obtain the optimized global model.

8. The method according to claim 7, wherein the optimizing, according to the respective pieces of staleness information and the target feedback information, the global model to be optimized to obtain the optimized global model comprises:
determining respective staleness weights corresponding to the respective pieces of staleness information, and performing a weighted average calculation on the respective pieces of staleness information to obtain average staleness information; and
optimizing, according to the average staleness information, the respective staleness weights and the target feedback information, the global model to be optimized to obtain the optimized global model.

9. The method according to claim 8, the optimizing, according to the average staleness information, the respective staleness weights and the target feedback information, the global model to be optimized to obtain the optimized global model comprises:
acquiring feedback information transmitted by the other electronic devices participating in the asynchronous federated learning, wherein the feedback information transmitted by the other electronic devices participating in the asynchronous federated learning and the target feedback information comprise respective corresponding updated model parameters;
determining an average updated model parameter, according to the respective corresponding updated model parameters comprised in the feedback information transmitted by the other electronic devices participating in the asynchronous federated learning and the target feedback information; and
optimizing, according to the average staleness information, the respective staleness weights and the average updated model parameter, the global model to be optimized to obtain the optimized global model.

10. The method according to claim 1, wherein the target feedback information is obtained by acquiring difference information of respective pieces of sample data in a sample data set for training the global model to be optimized, and performing, according to the difference information and the sample data set, training on the global model to be optimized.

11. The method according to claim 10, wherein the target feedback information is obtained by performing, according to the difference information, regularization processing on the global model to be optimized to obtain a processed global model, and performing, according to the sample data set, training on the processed global model.

12. The method according to claim 11, wherein the processed global model is obtained by determining, according to the difference information, a regularization weight parameter for training the global model to be optimized, and performing, according to the regularization weight parameter, the regularization processing on the global model to be optimized.

13. The method according to claim 1, wherein the target feedback information is compressed feedback information obtained by compression processing, and transmission resources of the compressed feedback information are less in number than transmission resources of pre-compression feedback information.

14. The method according to claim 13, wherein the compression processing comprises quantization compression processing; the compressed feedback information is acquired from a number of bits of the pre-compression feedback information, the pre-compression feedback information is subject to the quantization compression processing according to the number of bits of the pre-compression feedback information to obtain the compressed feedback information, wherein a number of bits of the compressed feedback information is less than the number of bits of the pre-compression feedback information.

15. The method according to claim 13, wherein the pre-compression feedback information comprises a plurality of sets of model parameters; the compression processing comprises sparse compression processing; the compressed feedback information is obtained by extracting at least one set of model parameters from the plurality of sets of model parameters, wherein the at least one set of model parameters is less in number than the plurality of sets of model parameters, and generating a sparse vector corresponding to the at least one set of model parameters.

16. A method for asynchronous federated learning, applied to an electronic device, comprising:
initiating a request for participating in the asynchronous federated learning to a server, and receiving a global model to be optimized that is fed back by the server based on the request for participating in the asynchronous federated learning, wherein the global model to be optimized is received when a first number is greater than a second number, the first number is a number of electronic devices that the server supports to participate in the asynchronous federated learning determined according to performance information of the server, and the second number is an acquired number of other electronic devices that have participated in the asynchronous federated learning; and
performing training on the global model to be optimized to obtain target feedback information, and transmitting the target feedback information to the server, wherein the target feedback information is used to optimize the global model to be optimized to obtain an optimized global model.

17. A method for predicting a business service, comprising:
acquiring a prediction request, wherein the prediction request is used to request prediction of a target business service; and
predicting the target business service based on an optimized global model that is pre-trained, to obtain a prediction result;
wherein the optimized global model is obtained based on the method according to claim 1.

18. An electronic device, comprising:
at least one processor; and
a memory communicatively connected to the at least one processor;
wherein the memory has, stored therein, an instruction executable by the at least one processor, and the instruction is executed by the at least one processor to enable the at least one processor to:
in response to a request for participating in the asynchronous federated learning sent by a target electronic device, determine, according to performance information of the server, a first number of electronic devices that the server supports to participate in the asynchronous federated learning;
acquire a second number of other electronic devices that have participated in the asynchronous federated learning;
if the first number is greater than the second number, send a global model to be optimized to the target electronic device;
receive target feedback information which is obtained by the target electronic device from training on the global model to be optimized; and
optimize, according to the target feedback information, the global model to be optimized to obtain an optimized global model.

19. An electronic device, comprising:
at least one processor; and
a memory communicatively connected to the at least one processor;
wherein the memory has, stored therein, an instruction executable by the at least one processor, and the instruction is executed by the at least one processor to enable the at least one processor to execute the method according to claim 16.

20. An electronic device, comprising:
at least one processor; and
a memory communicatively connected to the at least one processor;
wherein the memory has, stored therein, an instruction executable by the at least one processor, and the instruction is executed by the at least one processor to enable the at least one processor to execute the method according to claim 17.
